(19) United States
(12) Patent Application Publication
(10) Pub. No.: US 2017/0286534 A1
(43) Pub. Date: Oct. 5, 2017

(54) USER LOCATION PROFILE FOR PERSONALIZED SEARCH EXPERIENCE

(71) Applicant: Microsoft Technology Licensing, LLC, Redmond, WA (US)

(72) Inventors: Siddhartha Arora, Redmond, WA (US); Beibei Cheng, Redmond, WA (US); Zhiqing Hong, Bellevue, WA (US); Ovidiu Dan, Kirkland, WA (US)

(73) Assignee: Microsoft Technology Licensing, LLC, Redmond, WA (US)

(21) Appl. No.: 15/084,392

(22) Filed: Mar. 29, 2016

(51) Int. Cl. G06F 17/30

(52) U.S. Cl. CPC G06F 17/30702; G06F 17/30241; G06F 17/30386

(57) ABSTRACT

Architecture that enables the creation and utilization of a user location profile for a personalized search experience in recommendation systems. The user location profile does not necessitate login of the user to obtain user profile information such as a user ID. Rather, the identifying information associated with the user location can be a network address and/or a device identifier that identifies the particular device from which the user is performing a search or which auto-suggest is being initiated. The user location profile can then be used to identify items about which the user may want information. Once generated, a matching operation is performed between the user location profile and item profiles in a log. The matched item profiles related to the user's location information (the user physical location and/or or user interested location(s)) are identified and recommended to the user.

### BACKGROUND

Searching the myriad amounts of available can be time consuming. Thus, vendors are developing different ways in which to make the search experience more effective and efficient. The process for using a search recommendation system, in general, that for those items the user ranks highly, a user profile can be generated and then match the user profile with a log so that the other items can be recommended to the user. However, there are problems that exist in this conventional system. The items that the user likes usually encompass a wide variety of items, thereby making the creation of item profiles a challenge. Moreover, the user profile is not easy to build, since a large number of users may not be logged in, which typically enables access to the user preferences.

### SUMMARY

The following presents a simplified summary in order to provide a basic understanding of some novel implementations described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables the creation and utilization of a user location profile for a personalized search experience in recommendation and automatically-generated suggestion (“auto-suggest”) systems. The disclosed user location profile architecture does not necessitate login of the user to derive user profile information such as a user identifier (ID). Rather, the identifying information associated with the user (device) location can be a network address (e.g., an IP (Internet protocol) address) and/or a device identifier (e.g., MAC (media access control) address, cookie, etc.) that identifies the particular device from which the user is performing a search and to which recommendation/auto-suggest is being performed.

The user location profile can then be used to identify items the user may want to see. Such items can have associated item profiles. The item profiles can be the location information extracted from the queries the user types or documents links (e.g., URIs (uniform resource identifiers), URLs (uniform resource locators), etc.) that the user selects (e.g., clicks) during user engagement (interaction) with an application document such as a webpage via a browser application.

The user location profile can be configured to comprise both a user physical (e.g., geographical) location and one or more user interested locations (also referred to as locations of interest to the user). The user location profile comprises user physical location information and user interested location information (also referred to as location of interest information). The user physical location information can be derived from the user interested location information. The user interested location information can be obtained from signals such as user click history from prior searches. Thus, clicks made by the user as relate to link data (data in the link itself such as names that identify locations, people, coordinates, IP addresses, etc.), documents, document content (e.g., images, videos, audio, text, etc.), can be extracted from search logs and processed to identify the location for each link data, document, document content (if desired), etc., previously clicked by the user.

Once extracted, the user click information is processed using a reverse geocoder (e.g., a document understanding tool that identifies the latitude/longitude (lat/lon) coordinates for each item of click information). The reverse geocoder can employ a geo-ontology (geographical ontology) data source of location attributes such as entity names, addresses, zip codes, state, country, coordinate information, phone numbers, corporate information, etc., that can be used in the analysis of the user interested location information.

These coordinates are then clustered into an unlimited number of clusters to find candidate user physical locations. Each cluster is processed to identify the candidate user physical location for that cluster. Thus, four clusters yield at least four candidates of user physical locations. Aggregation is then applied to these candidates to find the most commonly identified location among these candidates. The most commonly identified location (the highest number of candidate instances) from the aggregation process is then determined to be the user physical location.

The click information obtained from the search logs (e.g., in an offline process) can comprise the links and corresponding timestamps as to when the links were engaged (interacted with) by the user. Thus, the extraction process from the search log looks at the timestamps backward in time a predetermined span of time, such as three months, six months, etc.

Another source of signals can be obtained from the user device. For example, ubiquitous portable devices such as cell phones and tablets can store large amounts of content related to photos, videos, text messages, voice mails, audio data, and so on, any number of which can be processed to identify the current user physical location and/or the user interested location. For example, cell phone photos and photo metadata can be processed to identify where/when the user device is currently located. Similarly, user audio files can be processed (recognized) to determine the dominant topics at any given point in time and from which the user physical location and/or user interested location can be determined. User text messages can be analyzed to identify the current user location, as well as email and calendar information as signals to assist in identifying these user locations (physical and interested). Additionally, these devices may include geographical location capability such as GPS (global positioning system) for accurate user physical and/or interested location determination.

Once generated, a matching operation is performed between the user location profile and item profiles in a log. The matched item profiles related to the user's location information (the user physical location and/or or user interested location(s)) are identified and recommended to the user. The user location profile enables a personalized and focused approach to identifying items (locations of interest) to return as recommended places and other content in the search results and/or for auto-suggest as related searches, for example. A matching process uses the user location profile to find relevant item profiles to recommend to the user. The user physical location information and/or the user interested location information of the user location profile can be used in the matching process to find the item profiles.

This recommendation process can be applicable to multiple different applications such as for auto-suggest in map search as well as any local related search (“local search”) on a user device. The architecture finds particular applicability to non-logged-in users, but works for logged-in users as well.

Accordingly, the disclosed architecture enables a recommendation system, comprising: an extraction component configured to extract location information from search data and source information associated with a device from which a search is performed; a profile generation component configured to generate a user location profile based on the search data and the source information; and a matching component configured to match the user location profile to a log of item profiles to recommend results.

The disclosed architecture also enables a computer-implemented recommendation method, comprising acts of: extracting geolocation data from search data of a user as part of a search process; clustering the geolocation data into geolocation clusters; identifying user location information of the user based on the geolocation clusters; and generating a user location profile from the user location information.

Still further, the disclosed architecture enables a computer-implemented recommendation method, acts of: extracting geolocation data from search history data of a non-logged-in user as part of a search process, the geolocation data based on a device identifier or a network address of a user device from which the non-logged-in user has performed searches; identifying user location information of the user based on geolocation clusters; and generating a user location profile from the user location information to include user physical location of the user and a location of interest of the user.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a recommendation system in accordance with the disclosed architecture.

FIG. 2 illustrates a flow diagram from search log extraction to the identification of the user physical location.

FIG. 3 illustrates a system of aggregation of multiple clusters of click data.

FIG. 4 illustrates a clustering system that identifies clusters for the user location profile.

FIG. 5 illustrates a system that generates an example user location profile in accordance with the disclosed architecture.

FIG. 6 illustrates a more detailed system of matching the user location profile to item profiles.

FIG. 7 illustrates a recommendation method in accordance with the disclosed architecture.

FIG. 8 illustrates an alternative method in accordance with the disclosed architecture.

FIG. 9 illustrates a block diagram of a computing system that executes a recommendation systems and methods in accordance with the disclosed architecture.

### DETAILED DESCRIPTION

Existing recommendation systems, in general, work on those items the user ranks highly. A user profile can be built based on those item profiles and then the item profiles matched against a log of item profiles so that the other items can be recommended to the user. However, problems in this general system include a wide variety of potentially unrelated items that the user likes, which introduces a challenge in creating item profiles. Moreover, the user profile is not easily constructed since a large number of users may not be logged in.

The disclosed architecture solves at least these problems by focusing on building a user location profile for personalized search experience whether or not the user is logged in. The user location profile architecture does not require the user to be logged in (conventionally using a login user ID). Rather, the user location profile can be generated using an IP (Internet protocol) address and/or a device identifier (ID). Therefore, item profiles can be the location information extracted from the user queries that user types and/or links that user selects.

It is to be appreciated that the IP address of the user physical location or the user interested location may be derived from an aggregation of multiple candidate IP addresses of respective locations. Selection of the final IP address can be made simply based on the number of the same IP addressed locations. Other techniques can include feature extraction from providers, machine learning for confidence normalization, and IP geolocation correction, for example.

The user location profile contains both the user physical location and user interested location(s) (also referred to as location(s) of interest to the user). The matched item(s) related with the user location (either the physical location or the interested locations) are recommended to the user. This recommendation architecture finds applicability in many different applications such as the auto-suggest in map search and for any local related search. Matching items are found by leveraging the user location profile. Additionally, user interested locations can be presented in a “Related searches” section of the document part as enhanced recommendation of places and/or included in the auto-suggest content.

The disclosed architecture exhibits technical effects rooted in computer technology to overcome problems specifically occurring in the realm of computer systems and networks. More specifically, the architecture enables improved usability by the user in terms of at least searching and suggestion recommendations for results and querying. By providing improved search recommendations, the amount of time the user spends attempting to find the desired information is reduced. This effect then provides a more efficient and effective utilization of personnel as well as a reduction in hardware and software operations. Such cost reductions (savings) become enormous when considering the millions of searches performed daily and the data centers and search engine frameworks that would be impacted by such searches, user-generated or otherwise.

Additionally, by deriving the item profiles the user wants to see and suggesting other closely-related item profiles, the architecture provides the user with enhanced reliability in getting the information desired. The architecture also imbues a reduced error rate in the results and queries returned to the user, thereby enabling the user and related systems to realize a correspondingly reduced amount of time in not only generating the results but also enabling the user to obtain the desired information and then move on to subsequent tasks.

Reference is now made to the drawings, wherein like reference numerals are used to refer to like elements throughout. In the following description, for purposes of explanation, numerous specific details are set forth in order to provide a thorough understanding thereof. It may be evident, however, that the novel implementations can be practiced without these specific details. In other instances, well known structures and devices are shown in block diagram form in order to facilitate a description thereof. The intention is to cover all modifications, equivalents, and alternatives falling within the spirit and scope of the claimed subject matter.

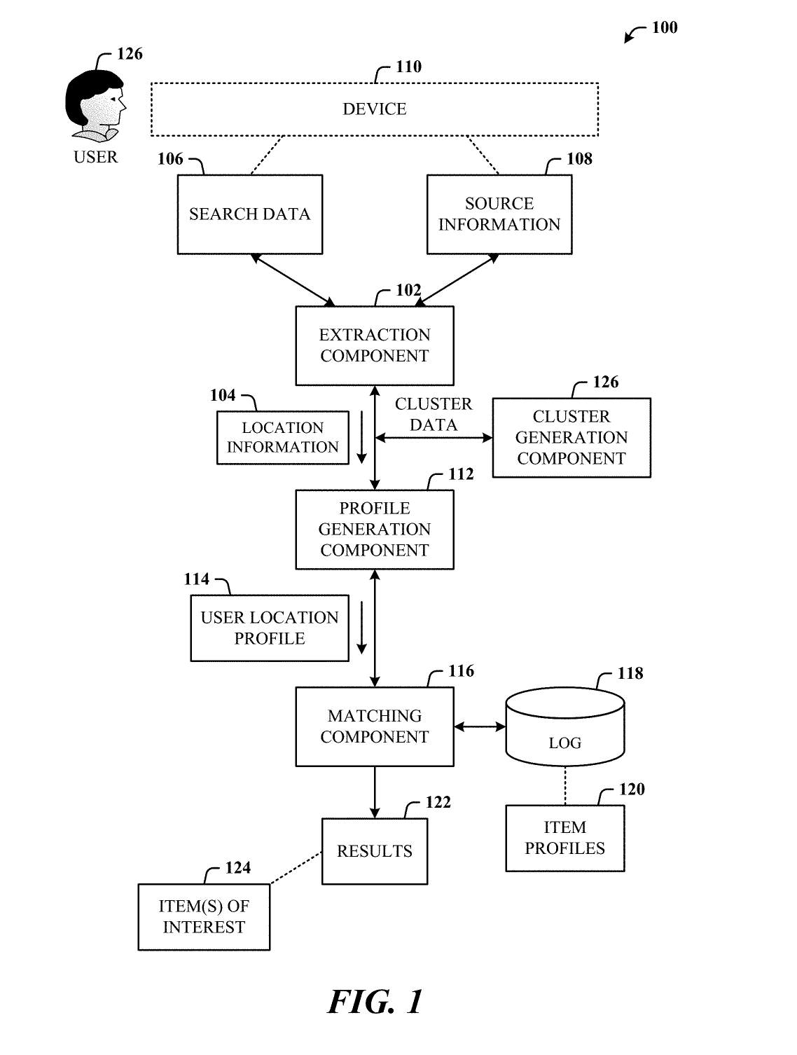

FIG. 1 illustrates a recommendation system 100 in accordance with the disclosed architecture. The system 100 can include an extraction component 102 configured to extract location information 104 from search data 106 and source information 108 associated with a device 110 from which a search is initiated. A profile generation component 112 is provided and configured to generate a user location profile 114 based on the search data 106 and the source information 108. A matching component 116 is provided and configured to match the user location profile 114 to a log 118 of item profiles 120 to enable the recommending of results 122 (e.g., search results, items of interest, locations of interest, item profiles, etc.).

The system 100 also includes a hardware processor, and a memory configured to store computer-executable instructions, where the instructions executed by the processor enable the components described herein.

The matching component 116 can be configured to match the user location profile 114 to the log 118 to find (match) and recommend items of interest 124 of a user 126 of the device 110 as a related search recommendation or as an automatic suggestion of content. The item profiles 120 comprise locations of interest to the user 126 associated with the user location profile 114. The search data 106 can include network addresses (e.g., IP (Internet protocol) addresses) of content clicked (e.g., user selected, via user interaction(s), etc.) and the source information 108, which is information that can identify (e.g., uniquely) the source or sources from which the source information 108 is obtained. Thus, the source information 108 can include a device identifier (e.g., MAC (media access code), device name, user name, device IP address, etc.) of the device 110.

The user location profile 114 can be employed for map application recommendations and local device searches, for example. The user location profile 114 can be generated and employed absent a user login profile. That is, the user location profile 114 can be generated for use for a non-logged-in user and/or a logged-in user. The profile generation component 112 generates the user location profile 114 using at least one of query tokens (terms of a query) or document click information (e.g., URIs (uniform resource identifiers), URLs (uniform resource locators), click-through data, and so on) that enables identifying the source of the document (e.g., text, image, video, audio, or any combination thereof).

The user location profile 114 can comprise the physical geographical location of the user (also referred to as the user physical location), a location of interest of the user, a source identifier of the user (e.g., an IP address), geolocation information (e.g., as geographical coordinates, triangulation information, GPS (global positioning system) coordinates, etc.), and location information (e.g., city, state, country, etc.). Other information that could be included can be street intersections (e.g., A Street and B Avenue), location names (e.g., the ABC Building), etc.

The system 100 can further comprise a cluster generation component 126 configured to generate clusters based on geographical coordinates (information) derived from content selected as part of one or more searches, and send cluster data to the profile generation component 112. The cluster data can include the centroid information of each cluster, which centroids then assist in defining the user physical location and the location of interest of the user, in the user location profile 114.

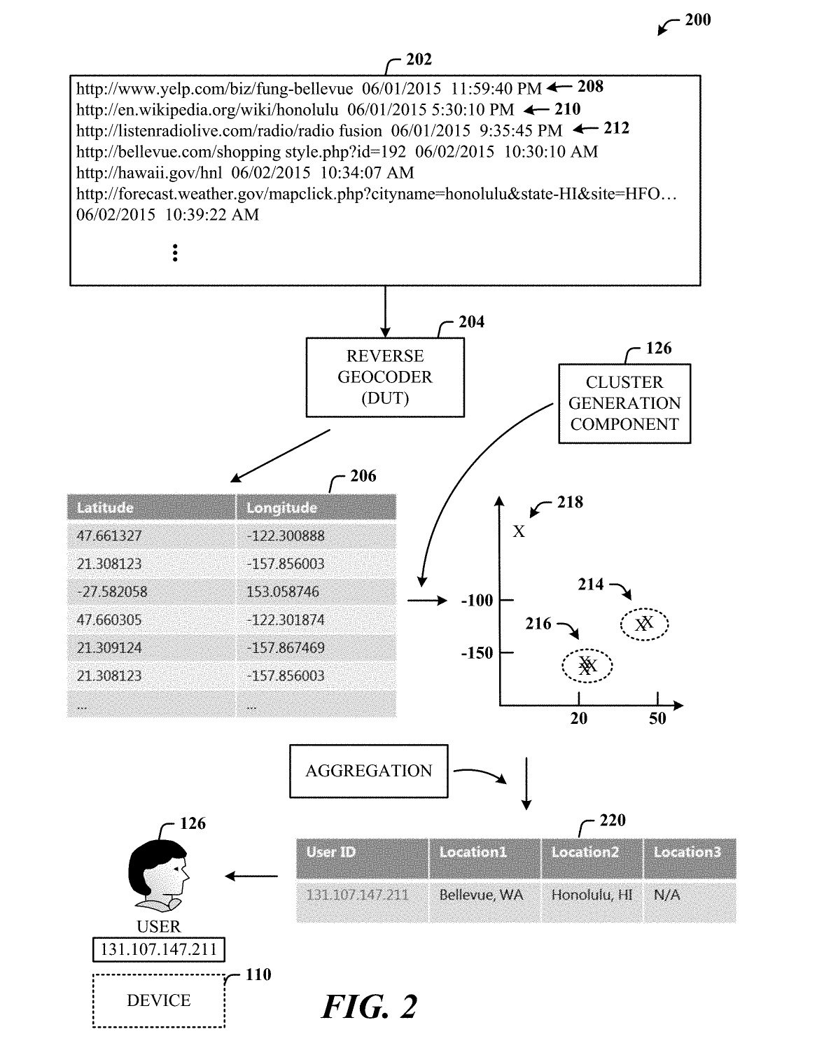

FIG. 2 illustrates a flow diagram 200 from search log extraction to the identification of the user physical location. Flow begins with the extraction of prior click information 202 items from search logs. A reverse geocoder 204 (e.g., a document understanding tool or algorithm) processes the click information 202 to output coordinate data 206 in the form of latitude/longitude pairs for each item.

For example, a first item 208 is a timestamped link, which includes the text “bellevue”, a second item 210 is a timestamped link, which includes the text “honolulu”, a third item 212 is a timestamped link, which includes the domain “listenradiolive.com”, and so on. The corresponding coordinate data 206 is listed for each item of click information 202.

The cluster generation component 126 processes the coordinate data 206 into clusters: a first cluster 214 (related to attributes associated with “bellevue”), a second cluster 216 (related to attributes associated with “hawaii” or “honolulu”), and a cluster 218 (related to attributes associated with “listenradiolive.com”). In this example, the resulting cluster information 220 is illustrated as a table of UserID and Location information, where Location1 is computed to be Bellevue, Wash., Location2 is computed to be Honolulu, Hi., and Location3 is computed to be irrelevant or indeterminable (denoted N/A). The ultimate user physical location for the user 126 (user device 110) is then computed to be the IP address of 131.107.147.211 for Bellevue, Wash.

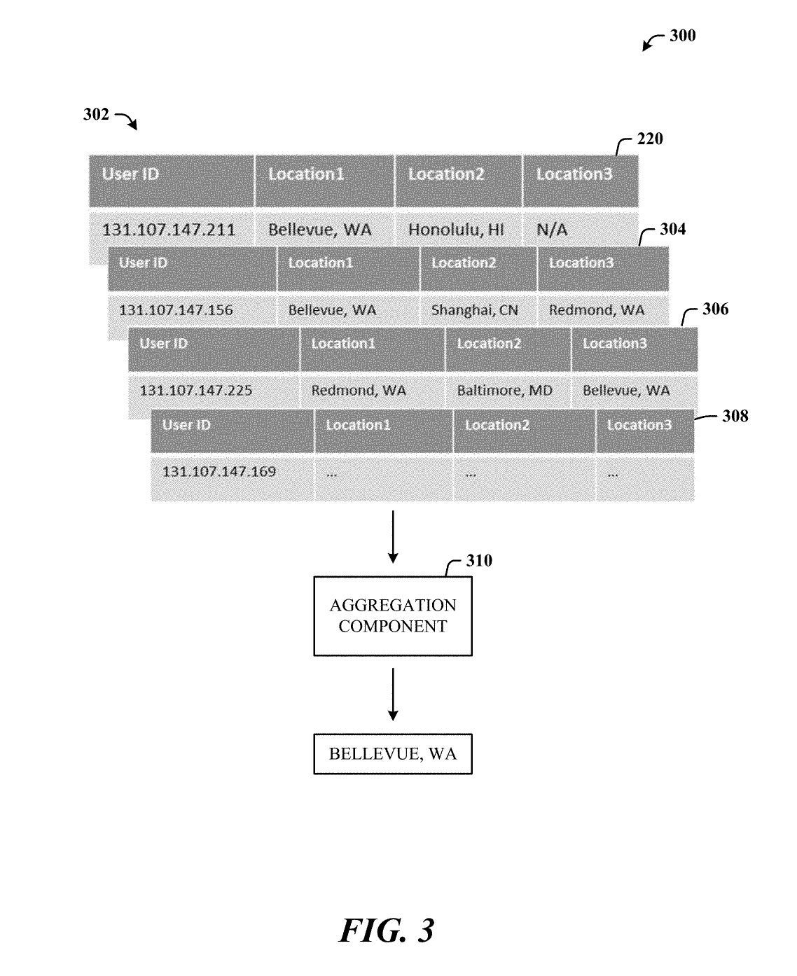

FIG. 3 illustrates a system 300 of the aggregation of multiple clusters of click data. Each cluster is identified with a different city: a first cluster for Bellevue; Wash.; a second cluster for Redmond, Wash.; a third cluster for Baltimore, Md.; a fourth cluster for Shanghai, CN; and, a fifth cluster for Honolulu, Hi. The number of data points in each cluster is three for Bellevue, two points for Redmond, one point for Baltimore, one point for Shanghai, and one point for Honolulu.

Here, click information (not shown, but similar to the click information 202), when reverse geocoded, results in four sets of candidate cluster information 302 each having lat/lon observations (or data points): the first set 220 of two lat/lon data points (from FIG. 2), a second set 304 of three lat/lon data points, a third set 306 of three lat/lon data points, and a fourth set 308 of no lat/lon data points. It is to be understood that the number of observations (locations) can be greater than three per set, as indicated in this example.

The first set 220, as previously indicated, identifies Bellevue, Wash., as Location1, Honolulu, Hi. as Location2, nothing (N/A) for Location3, and derives the IP address of 131.107.147.211 for the UserID. The second set 304 identifies Bellevue, Wash., as Location1, Shanghai, CN as Location2, Redmond, Wash. for Location3, and derives the IP address of 131.107.147.156 for the UserID. The third set 306 identifies Redmond, Wash., as Location1, Baltimore, Md. as Location2, Bellevue, Wash. for Location3, and derives the IP address of 131.107.147.225 for the UserID. The fourth set 308 identifies nothing for any of the locations (Location1, Location2, and Location3), and derives the IP address of 131.107.147.169 for the UserID.

An aggregation component 310 then aggregates these tables of cluster information 302 to identify the resulting user physical location of Bellevue, Wash. using the IP address of 131.107.147.211 as having the highest confidence level for being the correct user physical location. In this depiction of the candidate cluster information 302, the locations (Locationx) in the sets (202, 304, 306, and 308) are indicated as cities that are associated with the IP addresses; however, in operation, the city names can be IP addresses. Clustering is performed to identify the most likely physical location of the user, which can be the greatest number of instances that the location is assigned to the IP address. The clustering technique is applied to two-dimensional data—the latitude and longitude. The centroid of the largest cluster is selected as the user physical location. Aggregation counts the number of instances of a given location over the clusters. Here, the instances of Bellevue, Wash. outnumber the other instances; accordingly, Bellevue, Wash. is selected as the user physical location.

In this case, note that the IP addresses cover an IP address span of 131.107.147.0 to 131.107.147.255 or 256 IP addresses. The IP address can be employed since the IP addresses of respective nearby locations are typically similar or identical in the leading octets or bytes (the first two or three octets of a 4-octet designation (for IPv4 addressing)). For example, IP addresses are usually divided for different locations, and the IP addresses of 131.107.147.6 and 131.107.147.30 (for IPv4 addressing) may be two different physical locations, but geographically close to each other, given the identical leading bytes of 131, 107, and 147. This general rule can also apply for the hextets or bytes for IPv6 addressing.

Physical location includes latitude, longitude, and area (defined by a radius about the lat/lon point). Thus, when GPS can be used, the radius can be considered small (e.g., several meters) from the geographical user location of interest to the user physical location. Thus, there is a high level of confidence the derived user physical location is correct. In contrast, when coordinate location technologies such as GPS are not available, the radius from the user interested location can be lengthened (e.g., kilometers) to increase the likelihood the user physical location can be identified with a high level of confidence. Thus, the higher level of confidence in the user physical location translates into higher quality information or content returned to the user in the form of recommendations and auto-suggestions, for example.

Other types of geographical location technologies can be used as signals for identifying the user physical location and ultimately the user location profile. For example, geofence technology maps a geometrical shape such as a circle of radius five miles about an entity such as a business. When a user (potential customer) intersects that geofence at any point, the user physical location can be derived for that moment in time. For a moving entity such as a mobile user, the geofence applied to the moving user follows user movement and can serve to trigger a single for use in deriving the user physical location and ultimately the user location profile.

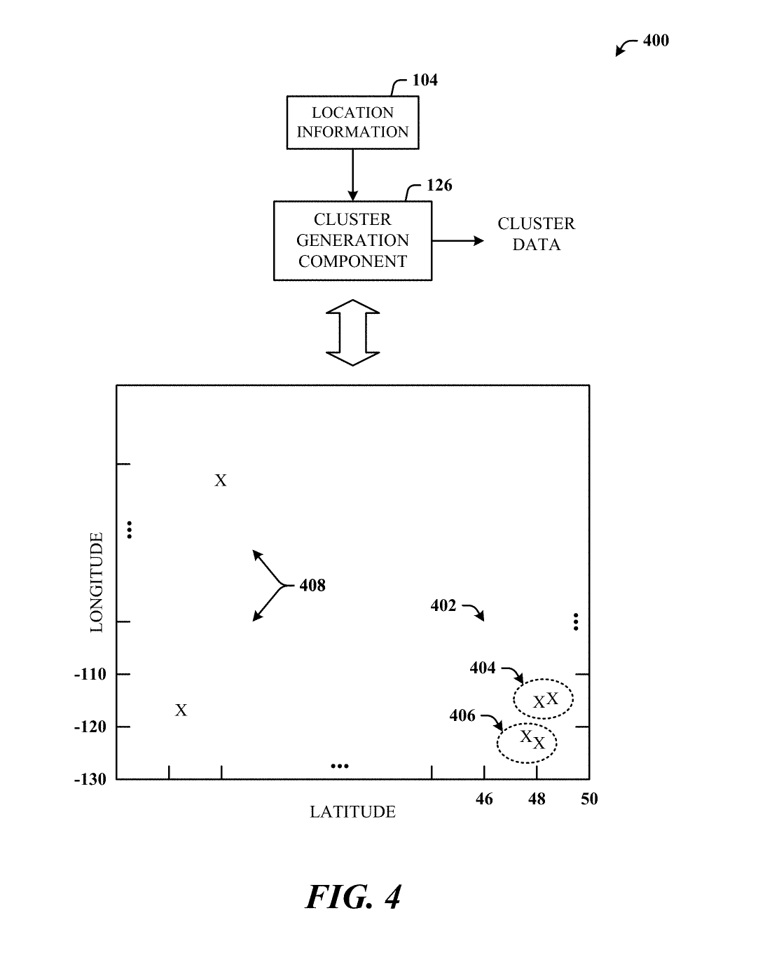

FIG. 4 illustrates a clustering system 400 that identifies clusters 402 for the user location profile 114. The location information 104, derived from the search data 106 and/or source information 108, is input into the cluster generation component 126 for processing to obtain the cluster data. The clusters 402 comprise a user physical location cluster 404 and a cluster 406 of the location of interest to the user. In this example, the user IP address is employed to identify the user physical location and the location of interest to the user. As previously indicated, the IP address can be employed since the IP addresses of respective nearby locations are typically identical in two or three of the leading bytes. As indicated herein, alternatively, or in combination therewith, a device identifier can be employed for cluster generation, and ultimately, identifying the user physical location and the location of interest of the user. Here, while there are two points 408 (all data points denoted as X's), the cluster algorithm (e.g., a density-based clustering algorithm such as DBSCAN) of the cluster generation component 126 identifies the two clusters 402 for the user location profile 114. The cluster generation component 126 also identifies a single representative point of each cluster such as the cluster centroid, for example.

In this example, the points of the clusters 402 are derived using geolocation coordinates of latitude (lat) and longitude (lon). The device IP address is being employed to identify the user physical location. The IP address can be obtained directly from the user device, a nearby network device, access points, a network service provider, transmitted packets associated with the user device, and other sources.

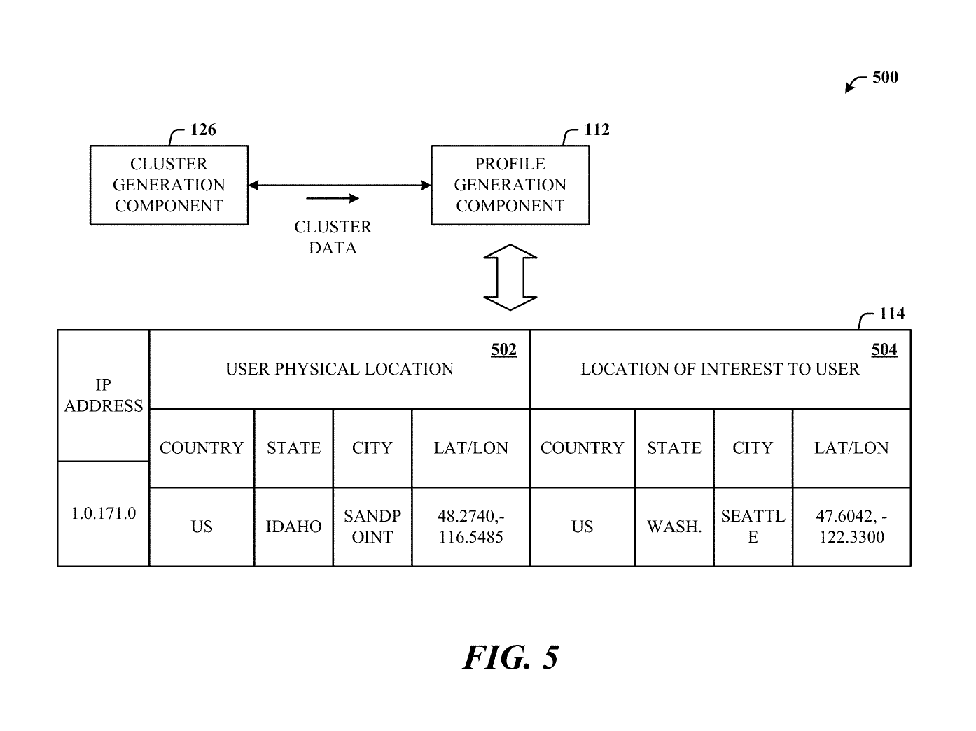

FIG. 5 illustrates a system 500 that generates an example user location profile 114 in accordance with the disclosed architecture. The cluster generation component 126 derives and sends the cluster data to the profile generation component 112 to create the user location profile 114. It can be the case that the cluster generation component 126 also obtains the location information (e.g., city, state, country, etc.) for the geolocation coordinates associated with the derived centroid to enable the profile generation component 112 to populate the user location profile 114.

In this example, the user location profile 114 is structured to include both the user physical location 502 and the location of interest to the user 504. The IP address (source information 108) of the user device is obtained and indicated as 1.0.171.0 and used to derive the user physical location 502 as being Sandpoint, Id., while the search data 106 is processed to identify the location of interest to the user 504 (the user interested location) as being Seattle, Wash. Additionally, the user physical location 502 lat/lon coordinates as (48.2740, −116.5485), and the location of interest of the user 504 as having lat/lon coordinates of (47.6042, −122.3300).

As previously indicated, the disclosed architecture can employ the device IP address and/or device identifier in the user location profile 114 to solve at least the existing non-login user problem. The user location profile 114 is employed to find (match) item profiles that are focused on the location information extracted from the query that user enters, or the network links (e.g., URLs) that user selects (e.g., clicks) to build user location profile. Since the user location profile 114 contains both the user physical location 502 and location(s) of interest to the user 504 (also referred to as user interested location(s)). The matched item(s) related to the user location (the user physical location 502 and/or user interested location 504) are recommended to the user. This recommendation process can occur in multiple applications such as the auto-suggest in map search as well as any related local search of a local geographical area.

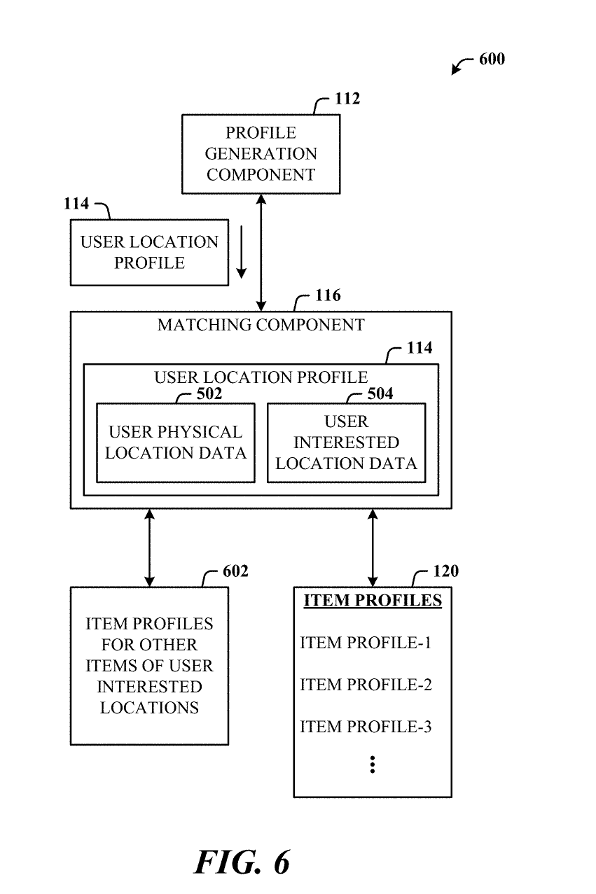

FIG. 6 illustrates a more detailed system 600 of matching the user location profile 114 to item profiles 120. In operation, the profile generation component 112 generates and sends the user location profile 114 to the matching component 116. The matching component 116 then users information of the user physical location 502 and/or the user interested location 504 in the matching process against the item profiles 120. When relevant item profiles are identified from the log 118 of profiles, these relevant item profiles can be returned as item profiles for other items of user interested location 602.

It is to be understood that in the disclosed architecture, certain components may be rearranged, combined, omitted, and additional components may be included. For example, the extraction component 102, profile generation component 112, matching component 116 and cluster generation component 126 can be hosted in any combination as part of the web-based search engine. Thus, the search data 106 and source information 108 can reside in a cloud or other network locations.

Additionally, in some implementations, all or some of the components are present on the client (e.g., device 110), while in other implementations some components may reside on a server or are provided by a local or remote service.

The disclosed architecture can optionally include a privacy component (not shown) that enables the user to opt in or opt out of exposing personal location information. The privacy component enables the authorized and secure handling of user information, such as tracking information, as well as personal information that may have been obtained, is maintained, and/or is accessible. The user can be provided with notice of the collection of portions of the personal information and the opportunity to opt-in or opt-out of the collection process. Consent can take several forms. Opt-in consent can impose on the user to take an affirmative action before the data is collected. Alternatively, opt-out consent can impose on the user to take an affirmative action to prevent the collection of data before that data is collected.

Included herein is a set of flowcharts representative of exemplary methodologies for performing novel aspects of the disclosed architecture. While, for purposes of simplicity of explanation, the one or more methodologies shown herein, for example, in the form of a flowchart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

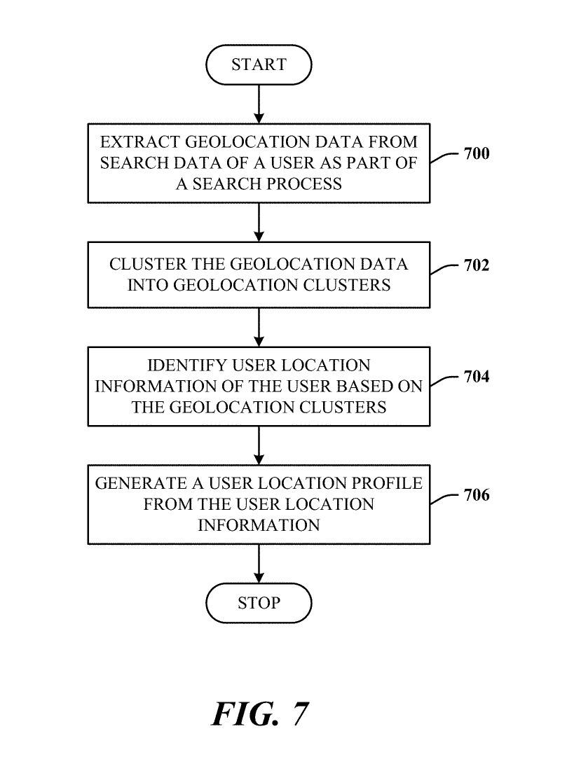

FIG. 7 illustrates a recommendation method in accordance with the disclosed architecture. The computer-implemented recommendation method comprises computer-executable instructions that when executed by a hardware processor, cause the hardware processor to perform the following acts. At 700, geolocation data is extracted from search data of a user as part of a search process. The search data can comprise queries, queries terms (or tokens), past searches (e.g., in the last few months), and so on. At 702, the geolocation data is clustered into geolocation clusters. Commonly-known clustering algorithms can be employed to perform clustering of the extracted geolocation data. At 704, user location information of the user is identified based on the geolocation clusters. Identifying the user location based on the geolocation clusters involves identifying the user location as corresponding to the location of one of the geolocation clusters. As indicated in the above example, a cluster of three instances of Bellevue, WA is selected due to the greatest number of instances. At 706, a user location profile is generated from the user location information.

The method can further comprise recommending new content (e.g., query terms, results, items, item profiles, etc.) to the user based on the user location profile. The method can further comprise generating the user location profile to include user physical location and a location of interest of the user. The method can further comprise extracting search history data associated with a network identifier relative to a span of time. Search history data can be obtained over a period of time such as the last six months, as obtained from the user device and/or online search logs.

The method can further comprise deriving an item profile from query entry information (e.g., query terms) and user selection information (e.g., URLs, URIs, etc.) of content, and processing the item profile against an item log to obtain items to present in a set of search results. The method can further comprise generating the user location profile for a non-logged-in user (and optionally, a logged-in user). Thus, the user location profile enhances the user experience for the non-logged in user, and can be used alone or in combination with the user profile of the logged-in user.

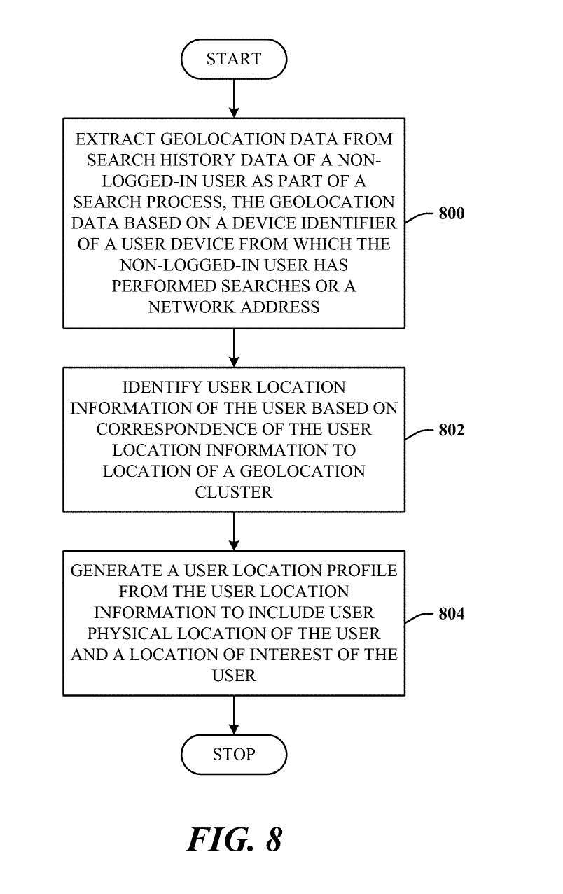

FIG. 8 illustrates an alternative method in accordance with the disclosed architecture. The computer-implemented recommendation method comprises computer-executable instructions that when executed by a hardware processor, cause the hardware processor to perform the following acts. At 800, geolocation data (e.g., geographical location (“geolocation”) coordinates) is extracted from search history data of a non-logged-in user as part of a search process. The geolocation data can be based on a device identifier of a user device from which the non-logged-in user has performed searches or a network address. At 802, user location information of the user is identified based on correspondence of the user location information to the location of a geolocation cluster. The “correspondence” can be the number of instances of a location or geographical coordinates for a geographical location. At 804, a user location profile is generated from the user location information to include user physical location of the user and a location of interest of the user.

The method can further comprise identifying the user physical location and the location of interest based on corresponding centroids of the geolocation clusters. The method can further comprise extracting links clicked by the user from a search log and identifying geolocation coordinates of the clicked links for coordinate clustering.

The method can further comprise recommending items to the user as part of the search process based on the user location profile (the user physical location and/or the user interested location) for a personalized search experience. The method can further comprise recommending an item in search results of an application based on matching of the user location profile to an item log.

As used in this application, the term “component” is intended to refer to a computer-related entity, either hardware, a combination of software and tangible hardware, software, or software in execution. For example, a component can be, but is not limited to, tangible components such as one or more microprocessors, chip memory, mass storage devices (e.g., optical drives, solid state drives, magnetic storage media drives, etc.), computers, and portable computing and computing-capable devices (e.g., cell phones, tablets, smart phones, etc.). Software components include processes running on a microprocessor, an object (a software entity that maintains state in variables and behavior using methods), an executable, a data structure (stored in a volatile or a non-volatile storage medium), a module (a part of a program), a thread of execution (the smallest sequence of instructions that can be managed independently), and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

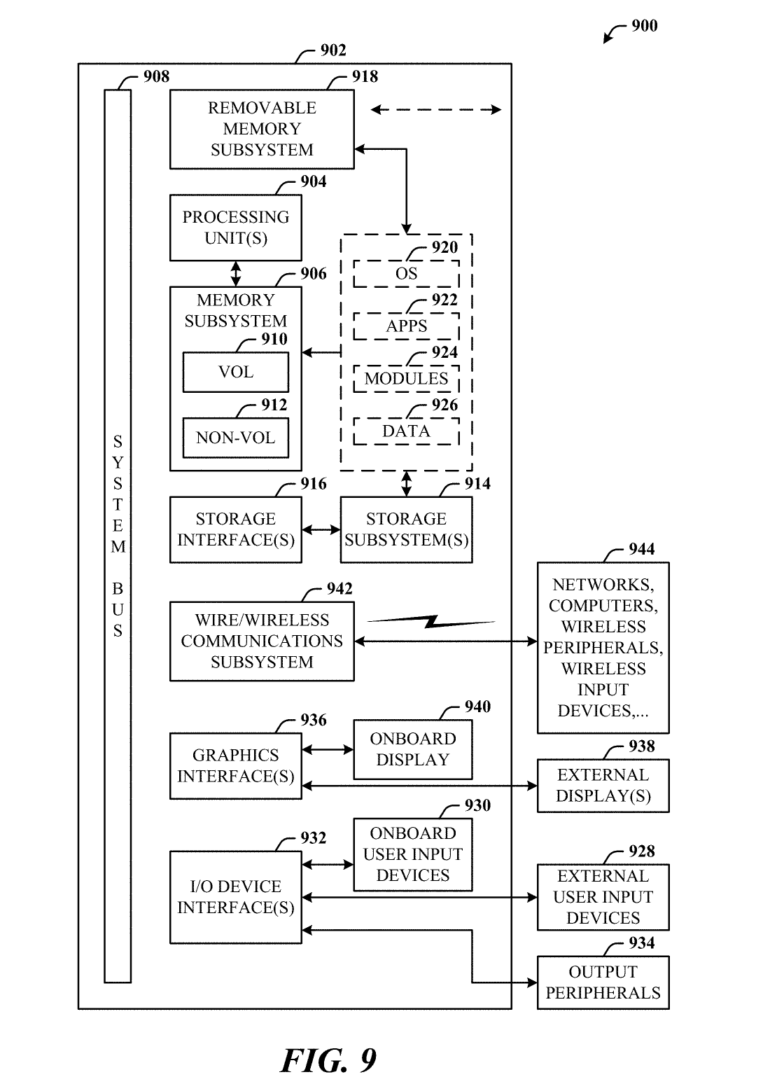

Referring now to FIG. 9, there is illustrated a block diagram of a computing system 900 that executes a recommendation systems and methods in accordance with the disclosed architecture. Alternatively, or in addition, the functionally described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc., where analog, digital, and/or mixed signals and other functionality can be implemented in a substrate.

In order to provide additional context for various aspects thereof, FIG. 9 and the following description are intended to provide a brief, general description of the suitable computing system 900 in which the various aspects can be implemented. While the description above is in the general context of computer-executable instructions that can run on one or more computers, those skilled in the art will recognize that a novel implementation also can be realized in combination with other program modules and/or as a combination of hardware and software.

The computing system 900 for implementing various aspects includes the computer 902 having microprocessing unit(s) 904 (also referred to as microprocessor(s) and processor(s)), a computer-readable storage medium (where the medium is any physical device or material on which data can be electronically and/or optically stored and retrieved) such as a system memory 906 (computer readable storage medium/media also include magnetic disks, optical disks, solid state drives, external memory systems, and flash memory drives), and a system bus 908. The microprocessing unit(s) 904 can be any of various commercially available microprocessors such as single-processor, multi-processor, single-core units and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 902 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 906 can include computer-readable storage (physical storage) medium such as a volatile (VOL) memory 910 (e.g., random access memory (RAM)) and a non-volatile memory (NON-VOL) 912 (e.g., ROM, EPROM, EEPROM, etc.). A basic input/output system (BIOS) can be stored in the non-volatile memory 912, and includes the basic routines that facilitate the communication of data and signals between components within the computer 902, such as during startup. The volatile memory 910 can also include a high-speed RAM such as static RAM for caching data.

The system bus 908 provides an interface for system components including, but not limited to, the system memory 906 to the microprocessing unit(s) 904. The system bus 908 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 902 further includes machine readable storage subsystem(s) 914 and storage interface(s) 916 for interfacing the storage subsystem(s) 914 to the system bus 908 and other desired computer components and circuits. The storage subsystem(s) 914 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) 916 can include interface technologies such as EIDE, ATA, SATA, and IEEE 1394, for example.

One or more programs and data can be stored in the memory subsystem 906, a machine readable and removable memory subsystem 918 (e.g., flash drive form factor technology), and/or the storage subsystem(s) 914 (e.g., optical, magnetic, solid state), including an operating system 920, one or more application programs 922, other program modules 924, and program data 926.

The operating system 920, one or more application programs 922, other program modules 924, and/or program data 926 can include items and components of the system 100 of FIG. 1, items and components of the flow diagram 200 of FIG. 2, items and components of the system 300 of FIG. 3, items and components of the clustering system 400 of FIG. 4, items and components of the system 500 of FIG. 5, items and components of the system 600 of FIG. 6, and the methods represented by the flowcharts of FIGS. 7 and 8, for example.

Generally, programs include routines, methods, data structures, other software components, etc., that perform particular tasks, functions, or implement particular abstract data types. All or portions of the operating system 920, applications 922, modules 924, and/or data 926 can also be cached in memory such as the volatile memory 910 and/or non-volatile memory, for example. It is to be appreciated that the disclosed architecture can be implemented with various commercially available operating systems or combinations of operating systems (e.g., as virtual machines).

The storage subsystem(s) 914 and memory subsystems (906 and 918) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 902, and include volatile and non-volatile internal and/or external media that is removable and/or non-removable. For the computer 902, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 902, programs, and data using external user input devices 928 such as a keyboard and a mouse, as well as by voice commands facilitated by speech recognition. Other external user input devices 928 can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the computer 902, programs, and data using onboard user input devices 930 such a touchpad, microphone, keyboard, etc., where the computer 902 is a portable computer, for example.

These and other input devices are connected to the microprocessing unit(s) 904 through input/output (I/O) device interface(s) 932 via the system bus 908, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 932 also facilitate the use of output peripherals 934 such as printers, audio devices, camera devices, and so on, such as a sound card and/or onboard audio processing capability.

One or more graphics interface(s) 936 (also commonly referred to as a graphics processing unit (GPU)) provide graphics and video signals between the computer 902 and external display(s) 938 (e.g., LCD, plasma) and/or onboard displays 940 (e.g., for portable computer). The graphics interface(s) 936 can also be manufactured as part of the computer system board.

The computer 902 can operate in a networked environment (e.g., IP-based) using logical connections via a wired/wireless communications subsystem 942 to one or more networks and/or other computers. The other computers can include workstations, servers, routers, personal computers, microprocessor-based entertainment appliances, peer devices or other common network nodes, and typically include many or all of the elements described relative to the computer 902. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 902 connects to the network via a wired/wireless communication subsystem 942 (e.g., a network interface adapter, onboard transceiver subsystem, etc.) to communicate with wired/wireless networks, wired/wireless printers, wired/wireless input devices 944, and so on. The computer 902 can include a modem or other means for establishing communications over the network. In a networked environment, programs and data relative to the computer 902 can be stored in the remote memory/storage device, as is associated with a distributed system. It will be appreciated that the network connections shown are exemplary and other means of establishing a communications link between the computers can be used.

The computer 902 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

The disclosed architecture can be implemented as a system, comprising: means for extracting geolocation data from search data of a user as part of a search process; means for clustering the geolocation data into geolocation clusters; means for identifying user location information of the user based on the geolocation clusters; and, means for generating a user location profile from the user location information.

The disclosed architecture can be implemented as an alternative system, comprising: means for extracting geolocation data from search history data of a non-logged-in user as part of a search process, the geolocation data based on a device identifier or a network address of a user device from which the non-logged-in user has performed searches; means for identifying user location information of the user based on correspondence of the user location information to location of a geolocation cluster; and, means for generating a user location profile from the user location information to include user physical location of the user and a location of interest of the user.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A recommendation system, comprising:
a hardware processor, and a memory configured to store computer-executable instructions, the instructions executed by the processor to enable:
an extraction component configured to extract location information from search data and source information associated with a device from which a search is initiated;
a profile generation component configured to generate a user location profile based on the search data and the source information; and
a matching component configured to match the user location profile to a log of item profiles to enable recommending of results.

2. The system of claim 1, wherein the matching component is configured to match the user location profile to the log to find and recommend items of interest as a related search recommendation or as an automatic suggestion of content.

3. The system of claim 1, wherein the item profiles comprise locations of interest to a user associated with the user location profile.

4. The system of claim 1, wherein the search data includes network addresses of content clicked and the source information includes a device identifier of the device.

5. The system of claim 1, wherein the user location profile is employed for map application recommendations and local device searches.

6. The system of claim 1, wherein the user location profile is generated and employed absent a user login profile.

7. The system of claim 1, wherein the profile generation component generates the user location profile using query tokens and document click information.

8. The system of claim 1, wherein the user location profile comprises a physical geographical location of the user and a location of interest of the user.

9. The system of claim 1, further comprising a cluster generation component configured to generate clusters based on geographical coordinates derived from content selected as part of one or more searches, and to send cluster data to the profile generation component.

10. A computer-implemented recommendation method, comprising computer-executable instructions that when executed by a hardware processor, cause the hardware processor to perform acts of:
extracting geolocation data from search data of a user as part of a search process;
clustering the geolocation data into geolocation clusters;
identifying user location information of the user based on the geolocation clusters; and
generating a user location profile from the user location information.

11. The method of claim 10, further comprising recommending new content to the user based on the user location profile.

12. The method of claim 10, further comprising generating the user location profile to include user physical location and a location of interest of the user.

13. The method of claim 10, further comprising extracting search history data associated with a network identifier relative to a span of time.

14. The method of claim 10, further comprising deriving an item profile from query entry information and user selection information of content, and processing the item profile against an item log to obtain items to present in a set of search results.

15. The method of claim 10, further comprising generating the user location profile for a non-logged-in user.

16. A computer-implemented recommendation method, comprising computer-executable instructions that when executed by a hardware processor, cause the hardware processor to perform acts of:
extracting geolocation data from search history data of a non-logged-in user as part of a search process, the geolocation data based on a device identifier of a user device from which the non-logged-in user has performed searches or a network address;
identifying user location information of the user based on correspondence of the user location information to location of a geolocation cluster; and
generating a user location profile from the user location information to include user physical location of the user and a location of interest of the user.

17. The method of claim 16, further comprising identifying the user physical location and the location of interest based on corresponding centroids of the geolocation clusters.

18. The method of claim 16, further comprising extracting links clicked by the user from a search log and identifying geolocation coordinates of the clicked links for coordinate clustering.

19. The method of claim 16, further comprising recommending items to the user as part of the search process based on the user location profile for a personalized search experience.

20. The method of claim 16, further comprising recommending an item in search results of an application based on matching of the user location profile to an item log.
